(19) United States
(12) Patent Application Publication
(10) Pub. No.: US 2026/0134225 A1
(43) Pub. Date: May 14, 2026

(54) TRACKING IDENTIFIED SOURCES FOR ATTRIBUTIONS TO REDUCE HALLUCINATIONS

(71) Applicant: GOOGLE LLC, Mountain View, CA (US)

(72) Inventor: Keun Soo Yim, San Jose, CA (US)

(21) Appl. No.: 18/943,585

(22) Filed: Nov. 11, 2024

(51) Int. Cl. G06F 40/40; G06N 3/0475

(52) U.S. Cl. CPC G06F 40/40; G06N 3/0475

(57) ABSTRACT

Disclosed implementations for reducing hallucinations in a generative model by tracking information flow in content provided by sources of information. A query and a selected source of information of the sources of information is received via a user interface. A plurality of candidate responses to the query is generated by the generative model based on the query and the plurality of sources of information. Each candidate response of the plurality of candidate responses includes a weighted summation for the plurality of sources and a scoring for each source of information of a plurality of sources of information. A candidate response of the plurality of candidate responses is selected based on the selected source of information, the scoring for each source of information, and a threshold value. The candidate response is provided via the user interface as a response to the query.

### BACKGROUND

Generative models (e.g., generative artificial intelligence (GenAI) and language models) are machine-learning models trained to generate a response (estimate the probability of a sequence of tokens, including words and/or emoji) in response to a prompt. Such language models have a high number of parameters (e.g., billions, hundreds of billions) and are commonly based on a transformer architecture. These models can generate realistic text or image responses to a prompt and can generate entirely new content, referred to as creative content.

### SUMMARY

Implementations described herein relate to systems and methods for determining a response to a query based on information provided via multiple sources of information where each source of information is assigned a trust level, via a generative model, based on a user's preferences. The generative model is trained to determine a context for a source by capturing patterns, tracking information flow, generating summaries from the input data, and assigning an intent to each source of information or each corpus. A technical advantage of disclosed implementations includes reducing hallucinations in a generative model by tracking information flow in content provided by sources of information.

In an example implementation, a query and a selected source of information of the sources of information is received via a user interface. A plurality of candidate responses to the query is generated by the generative model based on the query and the plurality of sources of information. Each candidate response of the plurality of candidate responses includes a weighted summation for the plurality of sources and a scoring for each source of information of a plurality of sources of information. A candidate response of the plurality of candidate responses is selected based on the selected source of information, the scoring for each source of information, and a threshold value. The candidate response is provided via the user interface as a response to the query.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

FIG. 1 depicts an example architecture that can be employed to execute implementations of the present disclosure.

FIG. 2 depicts an example generative system, according to disclosed implementations.

FIG. 3 depicts a flowchart of a non-limiting process that can be performed by implementations of the present disclosure.

FIG. 4 depicts an example of a distributed computer device that can be used to implement the described techniques.

### DETAILED DESCRIPTION

A technical problem with generative models is that their generated content can include inaccurate information because these models can generate content freely. The inaccurate generated content is referred to as a hallucination. Hallucinations are typically classified as intrinsic (against the provided input or context) and extrinsic (against the externally known facts). Detecting and/or reducing hallucinations is an important technical problem affecting the usefulness of generative models.

Accordingly, implementations described herein provide at least one technical solution to these technical problems by reducing hallucinations in generative models by tracking the flow of information in, for example, generating responses based on multiple sources of information (e.g., corpora). In some cases, the generative models are trained to determine a context for a source by capturing patterns, tracking information flow, generating summaries from the input data, and assigning an intent to each source of information or each corpus. As used herein, a corpus includes a group of sources having a common type (e.g., traditional news vs. social media), while a source of information is more specific within a corpus a specific news site (e.g., the NYTimes or Washington Post), social media (e.g., Instagram, Reddit, and Facebook), data aggregation sites, published papers, and so forth.

Unlike conventional generative models that use declarative statements or add conditions to the question (query), generative models trained and employed within the described system use statements that are conditional to the context of the topic being summarized (e.g., to provide a response to a query). Furthermore, the system trains a generative model to track the flow of information in each source of information to determine a context and generate responses based on these contexts as well as the information provided by each source of information. Implementations may also be used to improve the quality of responses provided by the generative model. For example, implementations may support an improved personal assistant that better understands a user's preferences, with user permission, based on a user's intent. Implementations can also provide a benchmark for building generative models. Thus, the user experience can be improved because information (e.g., query results, attribution of content, and the like) provided by generative models will better match the user's informational needs and thereby reduce the hallucinations of the model and in particular, hallucinations as perceived by the user.

In some cases, the system determines a proposition (e.g., a candidate response to a query) based on information provided via multiple sources of information where each source of information (or the respective corpus) is assigned a trust level. In some cases, a trust level is assigned by a developer during model training. In some cases, instead of the trust level being set by the developer at a global level (all output of the model), a user may select an available corpus, set of corpora, or specific sources of information for the hallucination detection at a local level (e.g., for output provided to the user from the model). For example, when summarizing information related to a particular topic, a developer may weigh one corpus (e.g., articles from the NY Times) over another (e.g., posts on Instagram) when training the underlying generative model. However, the described system also allows users to set a trustworthiness for one or more of the corpora (or source of a set of corpora). For example, a user may decide to weigh one corpus (e.g., Instagram Post by their former science professor) over another (e.g., articles from the NY Times).

In some cases, the system reduces extrinsic hallucination of generative models via the attribution of weighted values that are applied to each corpus. In some cases, a weighted value(s) may be applied to a particular source(s) that differs from the weighted value applied to the respective corpus that the source falls within. For example, a user may prefer a particular news source over other news sources (or disfavor the news source compared to the other news sources). In such cases, the generative model may apply a higher weight to the particular news source (or lesser weight) compared to other news sources during the attribution of weighted values. In some implementations, each corpus (or a set of corpora) is weighted using a weight function(s). The generative model is trained to provide response to queries based on the weighted corpora. In some cases, attribution is applied during training of the generative model (e.g., applied to training data).

In some implementations, the described system includes a service that sits atop the generative model (e.g., an extra layer on the model). The generative model may generate a number of candidate responses to a query that are annotated with information related to the source(s) used to determine the response and the relevant information and context (as determined by the model) provided by the source(s). For example, an annotation for a particular candidate response may include a specific document provided by a source and/or a specific section of the document as well as a scoring of the source (or section). In some cases, when providing a response to the query, the system employs the service to select one or more of the candidate responses based on the user's preferences and the annotations included in each candidate response.

### Example Environment

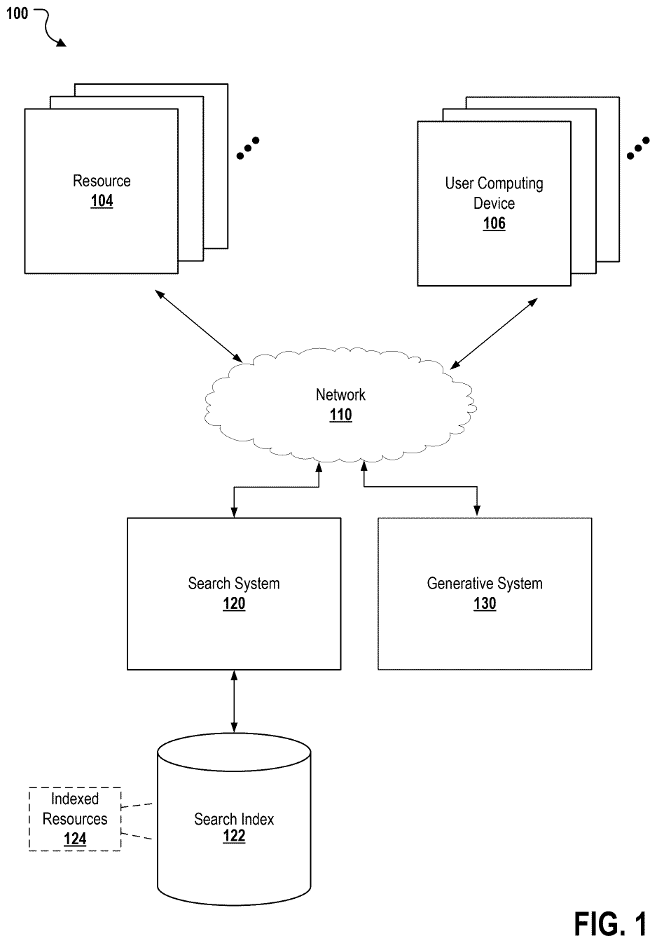

FIG. 1 is a block diagram of an example architecture in which users can interact with one or more generative models trained to provide an attribution process for multiple corpora that include related sources of information. As depicted, a communications network 110 connects user computing devices 106 with a search system 120, a generative system 130, and resources 104. The communications network 110 may include wireless and wired portions that may be accessed over a wired and/or a wireless communications link. For example, user computing devices 106, such as smartphones can use a cellular network to access the communications network 110. The environment 100 may include millions of resources 104 (e.g., provided via web site) and user computing devices 106. In some cases, the communications network 110 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a telephone network. The communications network 110 may also include future developed networks. In some implementations, the communications network 110 includes the Internet, an intranet, an extranet, or an intranet and/or extranet that is in communication with the Internet. In some implementations, the communications network 110 includes a telecommunication or a data network.

As used herein, resources 104 can refer to any content accessible by an identifier by a search engine or content, such as a dialog, provided by the user computing device 106 (e.g., in addition to the query). Thus, resources 104 may include web resources, documents, media (e.g., multimedia content), programming elements, and the like. Other example web resources include, but are not limited to, text, images files, video files, audio files, feed sources, and the like.

A web resource (e.g., a web page) includes data that can be provided over the communications network 110 via a resource address (e.g., a uniform resource locator (URL)). In some cases, the web resources 104 are formatted in a markup language (e.g., hypertext markup language (HTML), extensible markup language (XML), and the like). In some cases, the resources 104 (e.g., web resources) include embedded information such as metadata information, hyperlinks, embedded instructions (e.g., scripts) and the like. In some cases, the resources 104 are published by a resource provider via a website. Such a website may include a collection of the resources 104.

In some cases, the search system 120 and the generative system 130 as well as publishers of some of the resources 104 are associated with a domain(s) and hosted by one or more servers in one or more locations. In some cases, these one or more servers include a server-class hardware type device and/or computer systems using clustered computers and components to function as a single pool of seamless resources when accessed through the communications network 110. For example, such implementations may be used in data center, cloud computing, storage area network (SAN), and network attached storage (NAS) applications. In some implementations, the one or more servers are deployed using a virtual machine(s).

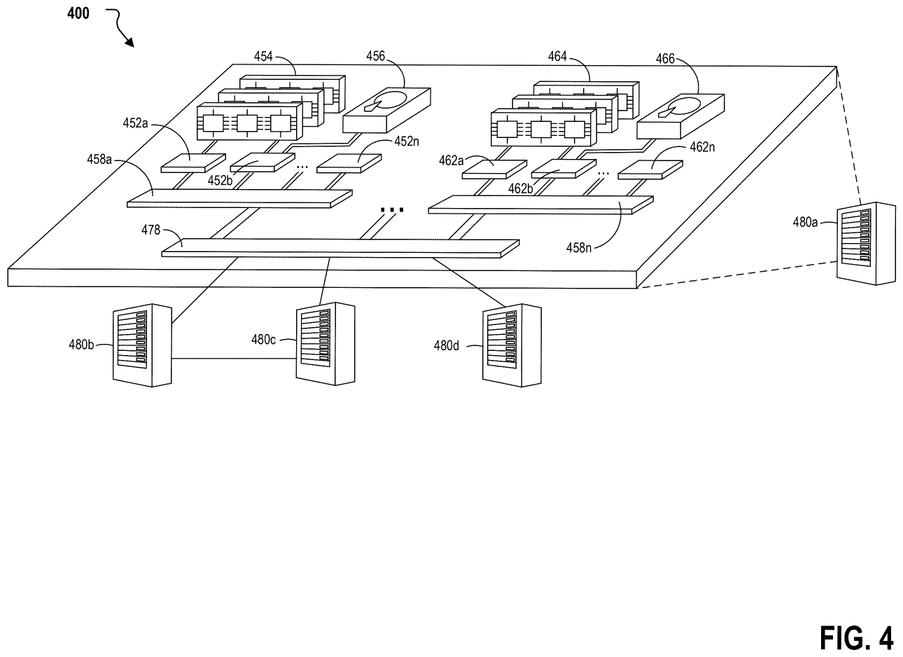

In some implementations, user computing device(s) 106 is an electronic device capable of requesting and receiving resources over the communications network 110. In some implementations, user computing device 106 is sustainably similar to the computing device 400 described below with reference to FIG. 4. Example user computing devices 106 include personal computers, mobile communication devices, tablet computers, Extended Reality (XR) devices, and the like. The user computing devices 106 may include (e.g., may each include) any appropriate type of computing device, such as a desktop computer, a laptop computer, a handheld computer, a tablet computer, a personal digital assistant (PDA), an augmented reality (AR)/virtual reality (VR) device, a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some implementations, the search system 120 accesses a search index 122 to search resources 104. In some implementations, the search index 122 includes a datastore of resources 104 (indexed resources 124) generated by crawling the information (e.g., web sites) provided by the publisher of the resource 104. In some implementations, the search index 122 is a repository for persistently storing and managing collections of data. Example data stores, such as the search index 122, that may be employed within the described system include data repositories, such as a database as well as simpler store types, such as files, emails, and so forth. In some implementations, the search index 122 includes a database. In some implementations, a database is a series of bytes or an organized collection of data that is managed by a database management system (DBMS).

In some implementations, the user computing devices 106 are configured to submit search queries to the search system 120 (e.g., via a web service provided by the search system 120). In some implementations, in response to each query, the search system 120 is configured to identify resources that are relevant to the query from the information stored in the search index 122. For example, the search system 120 may, for example, identify the resources 104 in the form of search results. Once generated, the search results are provided as part of a search result page to the user computing device 106 from which the query was received.

In some examples, a user computing device 106 can include one or more input modalities. Example input modalities can include a keyboard, a touchscreen, a mouse, a stylus, and/or a microphone. For example, a user can use a keyboard and/or touchscreen to type in a search query. As another example, a user can speak a search query, the user speech being captured through the microphone, and processed through speech recognition to provide the search query.

In response to receiving a search query, the search system 120 processes the query and accesses the search index 122 to identify resources 104 that are relevant to the search query (e.g., have at least a minimum specified relevance score for the search query). The search system 120 identifies the resources 104, generates a search result page. a search result page is generated by the search system 120 in response to a query. The search result page includes search results and can include other content, such as ads, knowledge panels, short answers, other types of rich results, links to limit the search to a particular resource type (e.g., images, travel, shopping, news, videos, etc.), other suggested searches, and the like. The resources were determined to be responsive to the query by the search engine. The search result includes a link to a corresponding resource. Put another way, each search result represents/is associated with a resource. The search result can include additional information, such as a title, a portion of text obtained from the content of the resource (e.g., a snippet), an image associated with the resource, etc., or other information relevant to the resource and/or the query, as determined by the search engine of the search system 120.

In some implementations, the generative system 130 trains and uses a generative model to provide responses to queries provided by the user computing devices 106. In some implementations, the generative system 130 may be co-located with the search system 120. In other words, in some implementations the generative system 130 and the search system 120 may be operated at the same server, which may be a distributed server. In some cases, the generative system 130 is supported by the search system 120; however, implementations are not limited to Internet search engines and can be supported by other types of search engines that are configured to provide resources responsive to a query.

In disclosed implementations, the generative system 130 may also send a query to the search system 120. The generative system 130 may use an application programming interface (API) of the search engine of the search system 120. The search engine API may return search results in a way that is not formatted for display, but instead enables the generative system 130 to read, analyze, and further process the information in a search result (e.g., the resource address, the relevant text extracted from the content, the title, etc.). In addition, the search engine API may enable the generative system 130 to request properties of the returned search results.

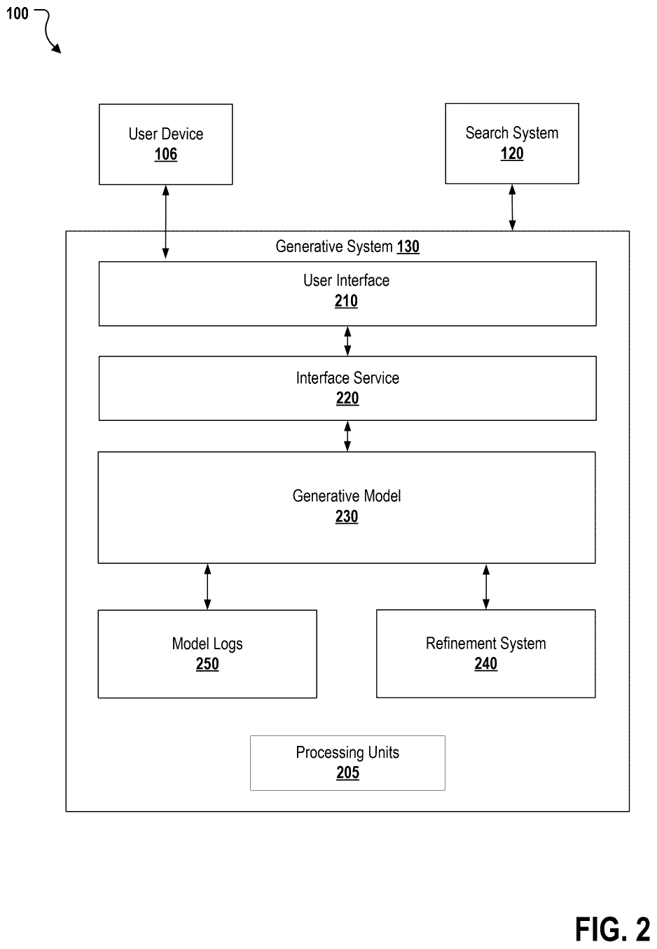

In accordance with implementations of the present disclosure, the example environment 100 also includes generative system 130 communicably coupled to the search system 120 (e.g., directly coupled or coupled over a network such as communications network 110). The generative system 130 may also be communicably coupled to a web site that provides one or more of the resources 104 and/or one or more of the user computing devices 106. In some implementations, the generative system 130 includes a generative model and is described in more detail with respect to FIG. 2.

FIG. 2 is a diagram that illustrates an example of the generative system 130, according to disclosed implementations. As described above, the generative system 130 may be configured to provide an attribution process for sources of information, which may be grouped into a plurality of corpora, and provide responses to queries accordingly. One or more of the components of the generative system 130 can be, or can include processors (e.g., processing units 205) configured to process instructions stored in a memory. Examples of such instructions as depicted in FIG. 2 include the user interface 210, interface service 220, generative model 230, refinement system 240, and model logs 250.

The user interface 210 is configured to receive prompts from the user device 106. A prompt can be any input received from the user device 106 (e.g., via user interface 210). In some examples, a prompt may include data and a query related to the data. For example, a prompt may include a query (e.g., provide a summarization of a particular topic based on a number of corpora) and preferred sources and/or corpora of the user. In some implementations, user interface 210 receives the prompts over a network interface, i.e., over a network such as the communications network 110. The user interface 210 can be configured to display a prompt input area. The prompt input area may take text as input. The user interface 210 may also be configured to display a response to the provided prompt. In some implementations, the user interface 210 may be part of (included in) another user interface. For example, the user interface 210 can be part of a search engine user interface, a browser tool or extension, a document extension or add in, and the like.

The user interface 210 may be configured to display a session. The user interface 210 may be configured to display a portion of a session. In some cases, a session includes prompts and responses (prompt rounds) and can be defined by a user. For example, the user interface 210 may include a control that enables the user to expressly start a new session. A session can be defined by a predetermined number of prompt rounds (a round being a prompt and its corresponding response). In such an implementation, a new session may begin after the predetermined number of prompt rounds. A session can be defined by a tab or window. For example, a session may encompass all prompt rounds occurring within the browser tab in which the user interface 210 is presented. In some implementations, the generative system 130 can expressly end a session based on some criteria (e.g., based on a topic or other characteristic of a prompt, number of prompt rounds, and so forth). An indication of the new session may be included in a final response for an ending session. A session is part of a prompt context. A prompt context can thus include a current prompt and the prior prompt rounds. If no prior prompt rounds exist, the prompt context may include the current prompt. In some implementations, the prompt context can include metadata (e.g.,). The metadata can include a number of prior prompt rounds. The metadata can include, with user permission, information about content displayed on a display of the user device 106, a topic and/or entity determined from the content displayed on the display, information about the user device 106 and/or user preferences (with user permission) relevant to the prompt, and the like.

In some implementations, the user interface 210 is configured to provide a prompt to the generative model 230 via the interface service 220. As depicted in FIG. 2, the interface service 220 provides a layer between the user interface 210 and the generative model 230. In some implementations, the generative model 230 is trained to generate a plurality of candidate responses based on both the explicit content from a source as well as an implicit intent behind the content to determine what information is provided by a particular source. In some implementations, the generative model 230 is trained to generate a plurality of candidate responses based on the prompt by varying trust levels and other equivalent characteristics to sources of information. In some implementations, the generative model 230 is trained to generate candidate responses based on both the explicit content from a source as well as an implicit intent behind the content to determine what information is provided by a particular source. For example, the trust level may be varied for each source based on weighted values used to generate a candidate response. In some implementations, the generative model 230 is trained to weight the available sources of information using a weight function(s) and depending on the provided prompt. In some cases, attribution is applied during training of the generative model 230 (e.g., is applied to the training data). For example, a developer may weigh one corpus over another when training the generative model 230.

As a simple example with source A and source B, the generative model may assign a higher level of trust to source A (as compared to source B) and generate a first candidate response to a query. Continuing with the example, the model may then assign a higher level of trust to source B (as compared to source A) and generate a second candidate response to the query. Thus, the first candidate response to the query weights information provided by source A more than source B while the second candidate response to the query weights information provided by source B more than source A.

In some cases, the generative model 230 is trained to assign a trust level to each corpus. In such cases, each source of information associated with a corpus may be assigned a trust level according to the trust level assigned to the respective corpus. Moreover, each corpus may be labeled for each premise derived for a particular context or topic. The labeling may be performed by a generative model (e.g., an LLM), other than generative model 230, or manually by a developer. In some cases, the generative model 230 may also include a rule-based (e.g., heuristics) model. A weighted value may then be set for each corpus.

In some implementations, the generative model 230 is trained to annotate each of the candidate responses with information related to the sources used to determine the respective candidate response. In some cases, an annotation includes, for example, a set of premises based on a prompt, weighted values assigned to each source, a weighted summation of the sources used to provide the candidate response, a scoring or an order of each source determined according to the weighted values, and the like. In some cases, an annotation for a particular candidate response may include a specific document provided by a source and/or a specific section of the document. In some cases, an annotation may also include contextual information for the resource, such as an intent, as determined by the generative model 230. For example, an annotation may include a summary of the intent of one of the sources in the context of the provided prompt and/or query included in the prompt. In some implementations, the generative model 230 is trained to determine a context for a source by capturing patterns, tracking information flow, generating summaries from the input data, and assigning an intent to each source of information.

In some cases, the interface service 220 is configured to use the preferences supplied via prompt to select a candidate response based on the annotations included in each candidate response. For example, the user may provide a higher value for information from a partial corpus (e.g., a new source in which the user has a high level of trust) than information from another corpus (e.g., a social media site in which the use has a love level of trust). In such an example, the interface service 220 may be configured to select a candidate response according to the weighted sum and a threshold function (a mathematical function that determines if an input value is greater than or equal to a threshold value and outputs a 1 or 0 based on the result) determined according to the provided user preferences. The interface service 220 provides the selected candidate response to the user device 106 via the user interface 210 as the response to the prompt.

In some implementations, the generative system 130 may generate model logs 250. Model logs 250 includes log records that capture a session. A session record includes at least a prompt and the generated response. Some session records in the model logs 250 may also capture the provided conversation and/or a summary of the conversation. The model logs 250 may be used by the refinement system 240 to generate training data used by the generative system 130 to further refine (fine-tune, train) the generative model 230. The refinement system 240 is configured to generate training data used to further train (refine) the generative model 230. The training data can include labeled training examples to assist with various training techniques, such as few-shot training.

### Example Process

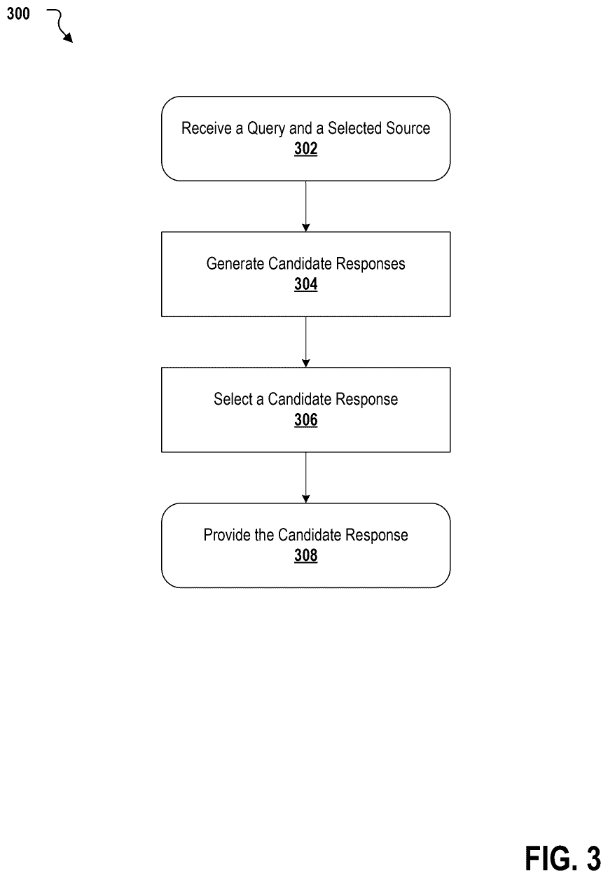

FIG. 3 depicts a flowchart of an example process 300 respectively that can be implemented by implementations of the present disclosure. The example process 300 can be implemented by systems and components described with reference to FIGS. 1 and 2. The example process 300 shows in more detail providing a candidate response as a response to the query based on a source of information that is selected by the user.

For clarity of presentation, the description that follows generally describes the example process 300 in the context of FIGS. 1 and 2. However, it will be understood that the process 300 may be performed, for example, by any other suitable system, environment, software, and hardware, or a combination of systems, environments, software, and hardware as appropriate. In some implementations, various operations of the process 300 can be run in parallel, in combination, in loops, or in any order.

At 302, the user interface 210 receives a prompt that includes a query and a selected source of information of a plurality of sources of information from the user device 106. In some implementations, the prompt includes a selected corpus of a plurality of corpora. In some implementations, the user interface 210 is configured to determine the selected source based on the selected corpus. In some implementations, the selected source is a member of the selected corpus. In some implementations, each source of information is a member of at least one corpus of the plurality of corpora. In some implementations, the plurality of corpora includes a news site, a social media site, a data aggregation site, or published papers.

From 302, the process 300 proceeds to 304 where the generative model 230 generates a plurality of candidate responses to the query based on the query and the plurality of sources of information.

In some cases, each candidate response of the plurality of candidate responses includes, in for example an annotation, a weighted summation for the plurality of sources and a scoring or an order of each source of information of the plurality of sources of information determined according to the weighted values. In some implementations, the generative model 230 is configured to generate each candidate response of the plurality of candidate responses by determining a context for each source of information of the plurality of sources of information and generating each candidate response of the plurality of candidate responses based in the context for each source of information. In some implementations, the context for each source of information includes an intent associated with content provided by the source of information.

From 304, the process 300 proceeds to 306 where the interface service 220 selects a candidate response of the plurality of candidate responses based on the selected source of information, the scoring for each source of information, and a threshold value. In some implementations, the interface service 220 is configured to determine the threshold value based on the weighted summation. For example, the interface service 220 may be configured to select the candidate response according to the weighted sum and a threshold function (a mathematical function that determines if an input value is greater than or equal to a threshold value and outputs a 1 or 0 based on the result) determined according to the provided user preferences. In some implementations, the interface service 220 selects the candidate response based on the scoring associated with the selected source of information meeting the threshold value.

In some implementations, the generative model 230 is trained to determine the scoring for each source of information of the plurality of sources of information based on weighted values applied to each source of information of the plurality of sources of information. In some implementations, the scoring associated with the selected source of information is associated with a document or a section of a document provided by the selected source of information. In some implementations, each source of information of the plurality of sources of information is a member a corpus of a plurality of corpora. In some implementations, the generative model 230 is trained to apply the weighted values to each source of information of the plurality of sources of information based on the corpus of the plurality of corpora to which the source is a member. In some implementations, the refinement system 240 is configured to train the generative model with the plurality of corpora and the weighted values.

From 306, the process 300 proceeds to 308 the user interface 210 provides the candidate response to the user device 106 as a response to the query. From 308, the process 300 ends or repeats.

### Example System

FIG. 4 shows an example of a computing device 400, which may be generative system 130 of FIGS. 1 and 2, which may be used with the techniques described here. The example computing device 400 can be programmed or otherwise configured to implement systems or methods of the present disclosure. Computing device 400 is intended to represent various example forms of large-scale data processing devices, such as servers, blade servers, data centers, mainframes, and other large-scale computing devices. Computing device 400 may be a distributed system having multiple processors, possibly including network attached storage nodes, that are interconnected by one or more communication networks. The components shown here, their connections and relationships, and their functions, are meant to be examples only, and are not meant to limit implementations of the implementations described and/or claimed in this document.

Computing device 400 may be a distributed system that includes any number of computing devices 480 (e.g., 480 a, 480 b, . . . 480n). Computing devices 480 may include a server or rack servers, mainframes, and the like. communicating over a local or wide-area network, dedicated optical links, modems, bridges, routers, switches, wired or wireless networks, etc.

In some implementations, each computing device may include multiple racks. For example, computing device 480 a includes multiple racks (e.g., 458a, 458b, . . . , 458n). Each rack may include one or more processors, such as processors 452a, 452b, . . . , 452n and 462a, 462b, . . . , 462n. The processors may include data processors, network attached storage devices, and other computer-controlled devices. In some implementations, one processor may operate as a master processor and control the scheduling and data distribution tasks. Processors may be interconnected through one or more rack switches 462a-462n, and one or more racks may be connected through switch 478. Switch 478 may handle communications between multiple connected computing devices 400.

Each rack may include memory, such as memory 454 and memory 464, and storage, such as 456 and 466. Storage 456 and 466 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 456 or 466 may be shared between multiple processors, multiple racks, or multiple computing devices and may include a non-transitory computer-readable medium storing instructions executable by one or more of the processors. Memory 454 and 464 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 454 may also be shared between processors 452a-452n. Data structures, such as an index, may be stored, for example, across storage 456 and memory 454. Computing device 400 may include other components not shown, such as controllers, buses, input/output devices, communications modules, and the like.

An entire system may be made up of multiple computing devices 400 communicating with each other. For example, device 480a may communicate with devices 480b, 480c, and 480d, and these may collectively be known as search system 120. Some of the computing devices may be located geographically close to each other, and others may be located geographically distant. The layout of computing device 400 is an example only and the system may take on other layouts or configurations.

It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Moreover, various implementations of the systems and techniques described herein can be realized in digital electronic circuitry, integrated circuitry, specially designed ASICs (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural or object-oriented programming language, or in assembly/machine language. As used herein, the terms “machine-readable medium” and “computer-readable medium” refers to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

What is claimed is:

1. A method comprising:
receiving, via user interface, a query and a selected source of information of a plurality of sources of information;
generating, via a generative model, a plurality of candidate responses to the query based on the query and the plurality of sources of information, wherein each candidate response of the plurality of candidate responses includes a weighted summation for the plurality of sources and a scoring for each source of information of the plurality of sources of information;
selecting a candidate response of the plurality of candidate responses based on the selected source of information, the scoring for each source of information, and a threshold value; and
providing, via the user interface, the candidate response as a response to the query.

2. The method of claim 1, wherein the generative model is configured to generate each candidate response of the plurality of candidate responses by:
determining a context for each source of information of the plurality of sources of information; and
generating each candidate response of the plurality of candidate responses based in the context for each source of information.

3. The method of claim 2, wherein the context for each source of information includes an intent associated with content provided by the source of information.

4. The method of claim 1, wherein scoring for each source of information of the plurality of sources of information is determined based on weighted values applied to each source of information of the plurality of sources of information.

5. The method of claim 4, wherein each source of information of the plurality of sources of information is a member a corpus of a plurality of corpora.

6. The method of claim 5, wherein the weighted values are applied to each source of information of the plurality of sources of information based on the corpus of the plurality of corpora to which the source is a member.

7. The method of claim 5, further comprising:
training the generative model with the plurality of corpora and the weighted values.

8. The method of claim 1, wherein the selected source is determine based on a selected corpus of a plurality of corpora, wherein the selected source is a member of the selected corpus, and wherein each source of information is a member of at least one corpus of the plurality of corpora.

9. The method of claim 8, wherein the plurality of corpora includes a news site, a social media site, a data aggregation site, or published papers.

10. The method of claim 1, further comprising determining the threshold value based on the weighted summation.

11. The method of claim 1, wherein the candidate response is selected based on the scoring associated with the selected source of information meeting the threshold value.

12. The method of claim 1, wherein the scoring associated with the selected source of information is associated with a document or a section of a document provided by the selected source of information.

13. A non-transitory computer-readable medium storing executable instructions that when executed by an electronic processor, cause the electronic processor to:
receive, via user interface, a query and a selected source of information of a plurality of sources of information;
generate, via a generative model, a plurality of candidate responses to the query based on the query and the plurality of sources of information, wherein each candidate response of the plurality of candidate responses includes a weighted summation for the plurality of sources and a scoring for each source of information of the plurality of sources of information;
select a candidate response of the plurality of candidate responses based on the selected source of information, the scoring for each source of information, and a threshold value; and
provide, via the user interface, the candidate response as a response to the query.

14. The non-transitory computer-readable medium of claim 13, wherein the generative model is configured to generate each candidate response of the plurality of candidate responses by:
determining a context for each source of information of the plurality of sources of information; and
generating each candidate response of the plurality of candidate responses based in the context for each source of information.

15. The non-transitory computer-readable medium of claim 14, wherein the context for each source of information includes an intent associated with content provided by the source of information.

16. A system comprising:
an electronic processor; and
a memory communicably coupled to the electronic processor and storing instructions that, when executed by the electronic processor, cause the system to:
receive, via user interface, a query and a selected source of information of a plurality of sources of information;
generate, via a generative model, a plurality of candidate responses to the query based on the query and the plurality of sources of information, wherein each candidate response of the plurality of candidate responses includes a weighted summation for the plurality of sources and a scoring for each source of information of the plurality of sources of information;
select a candidate response of the plurality of candidate responses based on the selected source of information, the scoring for each source of information, and a threshold value; and
provide, via the user interface, the candidate response as a response to the query.

17. The system of claim 16, wherein scoring for each source of information of the plurality of sources of information is determined based on weighted values applied to each source of information of the plurality of sources of information.

18. The system of claim 17, wherein each source of information of the plurality of sources of information is a member a corpus of a plurality of corpora.

19. The system of claim 18, wherein the weighted values are applied to each source of information of the plurality of sources of information based on the corpus of the plurality of corpora to which the source is a member.

20. The system of claim 18, wherein the instructions, when executed by the electronic processor, further cause the system to:
train the generative model with the plurality of corpora and the weighted values.
